(19) United States
(12) Patent Application Publication
(10) Pub. No.: US 2017/0015074 A1
(43) Pub. Date: Jan. 19, 2017

(54) SYSTEM AND METHOD FOR BUILDING AND CURING A TIRE CURING BLADDER

(71) Applicant: Bridgestone Americas Tire Operations, LLC, Nashville, TN (US)

(72) Inventor: Adam K. Nesbitt, Akron, OH (US)

(21) Appl. No.: 15/203,958

(22) Filed: Jul. 7, 2016

Related U.S. Application Data
(60) Provisional application No. 62/191,850, filed on Jul. 13, 2015.

(51) Int. Cl. B29D 30/26

(52) U.S. Cl. CPC B29D 30/26; B29D 2030/2635

(57) ABSTRACT

A system and method for building and curing a tire curing bladder is provided. In one embodiment, a system for curing a tire curing bladder is provided, the system comprising: a tire building drum, including: at least one end cap; and a cylindrical wall; wherein the tire building drum includes an axis of rotation and wherein the axis of rotation extends through the at least one end cap, and wherein the cylindrical wall includes at least one orifice; a mold, including: a mold ring oriented at least partially radially outwardly of the tire building drum; and at least one outside bead ring; and a tire curing press.

### CROSS-REFERENCE TO RELATED APPLICATIONS

This application claims priority from U.S. Provisional Patent Application No. 62/191,850, filed on Jul. 13, 2015, which is incorporated by reference herein in its entirety.

### BACKGROUND

Tire curing apparatuses, such as tire presses, typically cure or vulcanize a tire by applying both internal and external heat and pressure. A tire press uses a heated outer metal mold that serves to shape and vulcanize the outside of the tire. This is used in conjunction with a rubber tire curing bladder that is inflated in the inside of a tire carcass and heated to vulcanize the interior of the tire.

Due to the mechanical strain that tire curing bladders are subjected to and the special function they are called upon to perform, tire curing bladders are typically required to be of a custom size and dimension to meet the requirements of each different tire design. Forming a tire curing bladder may require a custom-made mold that is expensive and time-consuming to produce. Alternatively, tire curing bladders can also be hand-made and cured in an autoclave using a relatively time-consuming, high-cost manufacturing process.

Additionally, forming of some tire curing bladders may require an already-cured tire curing bladder oriented radially inside of a green, uncured tire curing bladder, wherein the cured tire curing bladder is inflated to cause the green, uncured tire curing bladder to take the shape of a mold.

What is needed is a system and method for manufacturing a tire curing bladder, which provides one with the ability to manufacture tire curing bladders of varying width, and/or which provides one with the ability to utilize existing or slightly modified tire building equipment.

### SUMMARY

In one embodiment, a system for curing a tire curing bladder is provided, the system comprising: a tire building drum, including: at least one end cap having at least one inside bead; and a cylindrical wall; wherein the tire building drum includes an axis of rotation and wherein the axis of rotation extends through the at least one end cap, and wherein the cylindrical wall includes at least one orifice; a mold, including: a mold ring oriented at least partially radially outwardly of the tire building drum, wherein the mold ring includes a first mold ring portion and a second mold ring portion, wherein each of the first mold ring portion and the second mold ring portion are oriented axially adjacent to one another; and at least one outside bead ring; and a tire curing press.

In another embodiment, a system for curing a tire curing bladder is provided, the system comprising: a tire building drum, including: at least one end cap; and a cylindrical wall; wherein the tire building drum includes an axis of rotation and wherein the axis of rotation extends through the at least one end cap, and wherein the cylindrical wall includes at least one orifice; a mold, including: a mold ring oriented at least partially radially outwardly of the tire building drum; and at least one outside bead ring; and a tire curing press.

### BRIEF DESCRIPTION OF THE DRAWINGS

The accompanying figures, which are incorporated in and constitute a part of the specification, illustrate various example systems and apparatuses, and are used merely to illustrate various example embodiments. In the figures, like elements bear like reference numerals.

FIG. 1 illustrates a sectional view of an example embodiment of a drum 100 for manufacturing a tire curing bladder 112.

FIG. 2A illustrates a sectional view of an example embodiment of a mold 201 for manufacturing a tire curing bladder 212.

FIG. 2B illustrates a sectional view of an example embodiment of mold 201 for manufacturing tire curing bladder 212.

FIG. 2C illustrates a sectional view of an example embodiment of mold 201 for manufacturing tire curing bladder 212.

FIG. 3 illustrates a sectional view of an example embodiment of a mold 301 for manufacturing a tire curing bladder 312.

FIG. 4 illustrates a sectional view of an example embodiment of a mold 401 for manufacturing a tire curing bladder 412.

FIG. 5 illustrates a sectional view of an example embodiment of a drum 500 for manufacturing a tire curing bladder 512.

FIG. 6 illustrates a sectional view of an example embodiment of a mold 601 for manufacturing a tire curing bladder 612.

FIG. 7 illustrates a sectional view of an example embodiment of a mold 701 for manufacturing a tire curing bladder 712.

### DETAILED DESCRIPTION

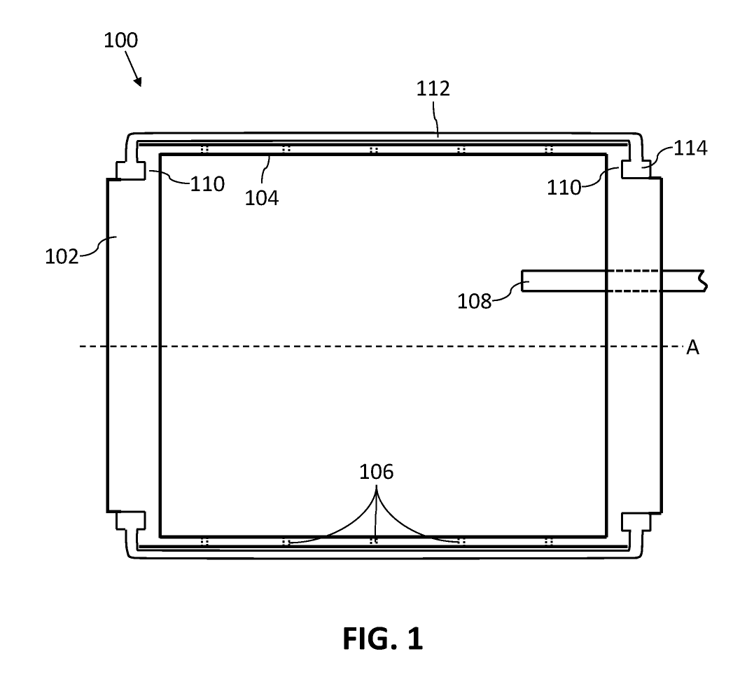

FIG. 1 illustrates a drum 100 for building a tire curing bladder 112. Drum 100 may include end caps 102 and a cylindrical wall 104. Cylindrical wall 104 may include at least one orifice 106. Drum 100 may include a fluid supply 108. Drum 100 may include at least one inside bead 110.

Drum 100 may be a cylindrical drum. Drum 100 may be a substantially cylindrical drum. Drum 100 may be a tire building drum. Drum 100 may be configured to rotate about an axis A oriented at its center, such that drum 100 may rotate similar to a wheel on a vehicle. Positions, such as “radially inward” and “radially outward” may be used herein with reference to axis A. Axis A may extend through at least one end cap 102.

Drum 100 may be devoid of end caps 102 or may be devoid of one end cap 102 while including one end cap 102. Drum 100 may include a substantially enclosed interior, bounded by end caps 102 and cylindrical wall 104. Drum 100 may be substantially air tight. Drum 100 may be substantially air tight, with the exception of at least one orifice 106 and fluid supply 108.

At least one orifice 106 may include any perforation, aperture, hole, channel, tube, or the like extending from an interior, or radially inner, side of cylindrical wall 104 to an exterior, or radially outer, side of cylindrical wall 104. At least one orifice 106 may fluidically connect an interior of drum 100 to an exterior of drum 100. At least one orifice 106 may permit passage of a gas, liquid, or any fluid, to pass from an interior (radially inner portion) of drum 100 to an exterior (radially outer portion) of drum 100. The fluid may be at least one of a heated fluid and a pressurized fluid.

In practice, fluid supply 108 may introduce a fluid, such as a gas, to the interior of drum 100. The gas may be pressurized. The gas may be heated. The gas may be pressurized and heated. The fluid may be steam. The gas, or other fluid, may flow, under pressure, through at least one orifice 106. Fluid supply 108 may be in fluid communication with the interior of drum 100. Fluid supply 108 may be in fluid communication with at least one orifice 106.

Tire curing bladder 112 may include any of a variety of materials, including for example, a polymer, a rubber, a metal, an alloy, a textile, and the like. Tire curing bladder 112 may be pliable in at least one of its uncured state and its cured state. Tire curing bladder 112 may be extendible in at least one of its uncured state and its cured state. Tire curing bladder 112 may be deformable in at least one of its uncured state and its cured state.

Tire curing bladder 112 may be formed about the outside surface of cylindrical wall 104. Tire curing bladder 112 may be substantially cylindrical in shape. Tire curing bladder 112 may be built on drum 100. Tire curing bladder 112 may be built on drum 100 using a layering process. The layering process may include the application of homogenous layers of the same compound to drum 100. The layering process may include the application of homogenous layers of the same compound, different compounds, or a combination of any number of layers of any number of compounds, to drum 100. Tire curing bladder 112 may be a single layer of a compound. Tire curing bladder 112 may be a calendared layer of a compound.

A gas, a liquid, or another fluid may be introduced into an interior of drum 100 via fluid supply 108. The fluid may pass through at least one orifice 106 and into contact with tire curing bladder 112, which may be oriented about the radially outer side of cylindrical wall 104.

Tire curing bladder 112 may include at least one foot 114. At least one foot 114 may at least partially engage inside bead 110. Tire curing bladder may include two feet 114, one on a first end and one on a second end. Drum 100 may include two inside beads 110, one on a first end and one on a second end. Each of feet 114 may at least partially engage an inside bead 110. At least one foot 114 may at least partially engage at least one inside bead 110 via a clamping arrangement. At least one foot 114 may at least partially engage at least one inside bead 110 via any of a variety of fasteners, including for example: a clamp, an adhesive, an interference fit, a pin, a threaded fastener, and the like.

In one embodiment, at least one foot 114 is at least partially engaged in a clamping arrangement between an inside bead 110 and an outside bead ring (not shown), such that a clamping force is provided between inside bead 110 and an outside bead ring. At least one foot 114 may at least partially engage an outside bead ring (not shown).

It is understood that at least one inside bead 110 and at least one foot 114 may extend circumferentially about a cylindrical drum 100.

In one embodiment, tire curing bladder extends into at least one inside bead 110 region of drum 100, wherein inside bead 110 acts as a mold to form at least a portion of foot 114.

At least one foot 114 may include two portions of a foot, including an inner portion (oriented axially inwardly toward the center of drum 100), and an outer portion (oriented axially outwardly away from the center of drum 100.

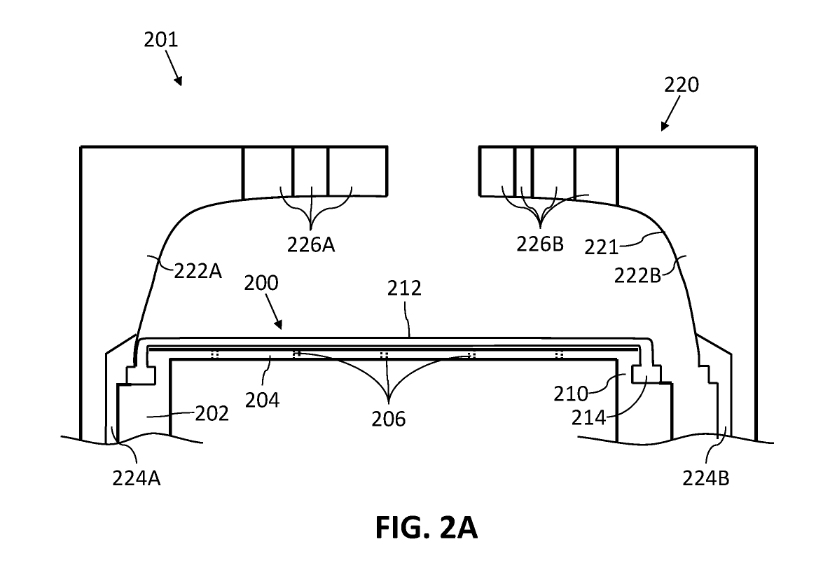

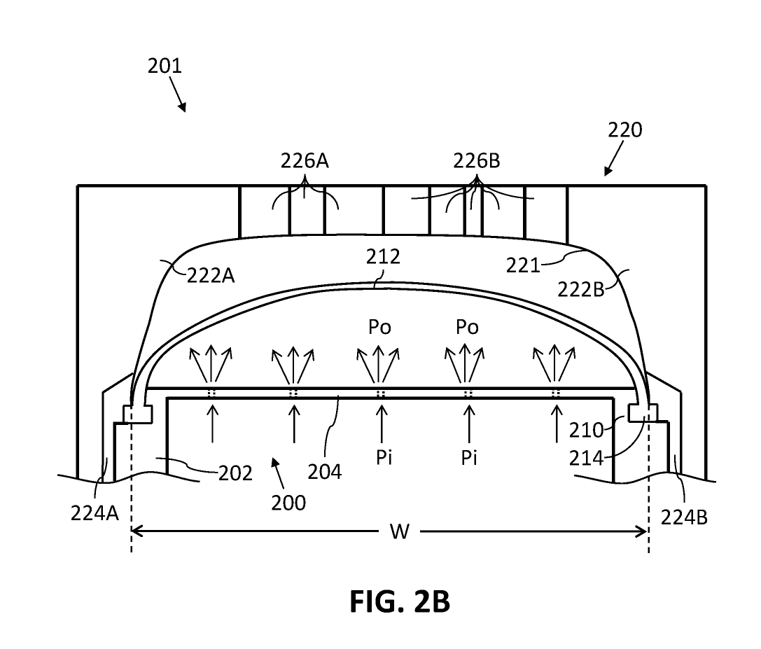

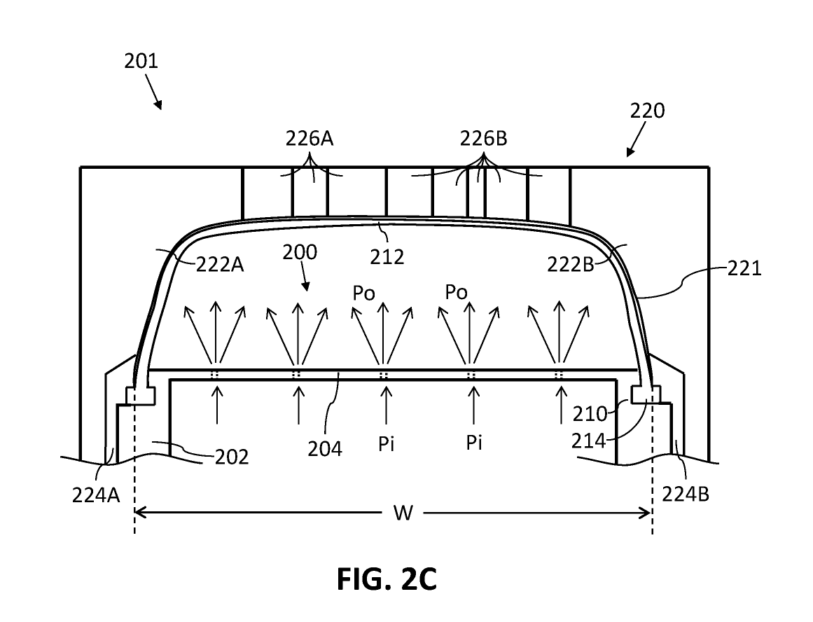

FIG. 2A illustrates a sectional view of a mold 201 for manufacturing a tire curing bladder 212. Mold 201 may be used in conjunction with a drum 200.

Drum 200 may include at least one end cap 202, a cylindrical wall 204, and at least one orifice 206 oriented in cylindrical wall 204. Drum 200 may include at least one inside bead 210. A tire curing bladder 212 may be built upon drum 200. Tire curing bladder 212 may include at least one foot 214. At least one foot may at least partially engage at least one inside bead 210.

Mold 201 may include at least one mold ring 220. As illustrated in FIG. 2A, mold ring 220 may be axially separated to permit loading of drum 200 and tire curing bladder 212 to the interior of mold ring 220. As illustrated in FIG. 2B and FIG. 2C, mold ring 220 may be axially closed to permit molding of tire curing bladder 212.

Mold ring 220 may include an inner surface 221. Inner surface 221 may include a profile substantially the same as the desired exterior profile of the tire curing bladder 212 after curing. Inner surface 221 may have a substantially concave profile. Inner surface 221 may include a texture (not shown). Inner surface 221 may include a smooth surface. Once assembled, as illustrated in FIG. 2B and FIG. 2C, inner surface 221 and drum 200 may form a chamber. The chamber may be bounded by inner surface 221 and cylindrical wall 204. The chamber may be substantially annular in shape.

Mold ring 220 may be a full-circle mold ring, extending completely circumferentially about drum 200. Mold ring 220 may be a segmented mold ring, extending partially about drum 200, and fixed to other segmented mold rings to form a complete circumferential mold about drum 200.

Mold ring 220 may include a plurality of mold portions, including a first mold ring portion 222A and a second mold ring portion 222B. First mold ring portion 222A may be oriented on a first side of drum 200. Second mold ring portion 222B may be oriented on a second side of drum 200, substantially opposite first mold ring portion 222A.

At least one of first mold ring portion 222A and second mold ring portion 222B may be selectively fixed to drum 200 after assembly of the mold 201 and building of tire curing bladder 212 on drum 200. At least one of first mold ring portion 222A and second mold ring portion 222B may be selectively fixed to drum 200 via any of a variety of mechanisms, including for example, a fastener such as a threaded fastener, a pin, a clamp, an interference fit, and the like.

Mold 201 may include at least one outside bead ring, including in one embodiment a first outside bead ring 224A and a second outside bead ring 224B. In one embodiment, at least one of outside bead ring 224A, 224B is integrally connected to at least one of first mold ring portion 222A and second mold ring portion 222B. At least one of outside bead ring 224A, 224B may be removably connected to at least one of first mold ring portion 222A and second mold ring portion 222B. At least one of first outside bead ring 224A and second outside bead ring 224B may be selectively fixed to first mold ring portion 222A and second mold ring portion 222B, respectively, via any of a variety of mechanisms, including for example, a fastener such as a threaded fastener, a pin, a clamp, an interference fit, and the like.

In one embodiment, at least one foot 214 is at least partially engaged in a clamping arrangement between an inside bead 210 and at least one outside bead ring 224A, 224B, such that a clamping force is provided between inside bead 210 and at least one outside bead ring 224A, 224B. For example, as illustrated in FIG. 2A, at least one foot 214 is at least partially engaged between inside bead 210 and first outside bead ring 224A. As illustrated in FIG. 2B, at least one foot 214 is at least partially engaged between inside bead 210 and second outside bead ring 224B.

In one embodiment, tire curing bladder extends into at least one inside bead 210 region of drum 200, wherein inside bead 210 acts as a mold to form at least a portion of foot 214. Likewise, at least one of outside bead ring 224A, 224B may act as a mold to form at least a portion of foot 214. At least one foot 214 may include two portions of a foot, including an inner portion (oriented axially inwardly toward the center of drum 200), and an outer portion (oriented axially outwardly away from the center of drum 200. In one embodiment, an inner portion of foot 214 is formed by at least one inside bead 210, while an outer portion of foot 214 is formed by at least one outside bead ring 224A, 224B.

Mold 201 may include at least one mold spacer ring. At least one mold spacer ring may include at least one mold spacer ring 226A oriented on first mold ring portion 222A. At least one mold spacer ring may include at least one mold spacer ring 226B oriented on second mold ring portion 222B.

As illustrated in FIG. 2B, first mold ring portion 222A and second mold ring portion 222B may be moved axially toward one another such that they come into contact with one another. When mold 201 is in a closed position, as illustrated in FIG. 2B, inner surface 221 may form a substantially continuous surface. In one embodiment, first outside bead ring 224A clamps a first foot 214 relative to a first inside bead 210, and second outside bead ring 224B claims a second foot 214 relative to a second inside bead 210.

The axially outer edges of tire curing bladder 212 may be separated by a distance or width W. Width W may be any of a variety of distances. One may select a width W based upon the section width or other width of a tire one wishes to cure using tire curing bladder 212. In one embodiment, mold spacer rings 226A, 226B may be added to mold 201 and mold ring portions 222A, 222B to increase the width W. Mold spacer rings 226A, 226B may be removed from mold 201 and mold ring portions 222A, 222B to decrease the width W. In this manner, one may utilize the same mold 201 and mold ring portions 222A, 222B to manufacture tire curing bladders 212 having any of various widths W, which may be used with various tires having various section widths.

Mold spacer rings 226A, 226B may be selectively fixed within mold 201 and between mold portions 222A, 222B via any of a variety of mechanisms, including for example a fastener, a clamp, an interference fit, and the like.

In practice, a fluid may be introduced to the interior of drum 200, for example via a fluid supply, such as fluid supply 108 in FIG. 1. The fluid may pass through at least one orifice 206 and cause tire curing bladder 212 to inflate. Tire curing bladder 212 may be inflated until it contacts inner surface 221. Tire curing bladder 212 may be inflated until it contacts the entirety of inner surface 221.

The fluid may be under a pressure Pi as it enters at least one orifice 206. The fluid may continue under pressure Po to inflate tire curing bladder 212. Pressure Pi may be about equal to pressure Po. Pressure Pi may be equal to pressure Po.

FIG. 2B illustrates tire curing bladder 212 in a partially inflated state. FIG. 2C illustrates tire curing bladder 212 in a completely inflated state, at which point tire curing bladder 212 may be cured while taking the shape of inner surface 221.

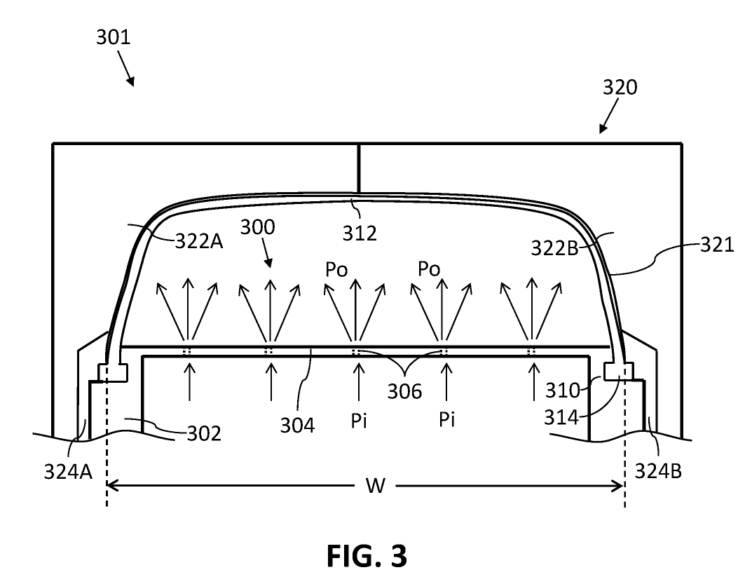

FIG. 3 illustrates a sectional view of a mold 301 for manufacturing a tire curing bladder 312. Mold 301 may be used in conjunction with a drum 300.

Drum 300 may include at least one end cap 302, a cylindrical wall 304, and at least one orifice 306 oriented in cylindrical wall 304. Drum 300 may include at least one inside bead 310. A tire curing bladder 312 may be built upon drum 300. Tire curing bladder 312 may include at least one foot 314. At least one foot may at least partially engage at least one inside bead 310.

Mold 301 may include at least one mold ring 320. As illustrated in FIG. 3, mold ring 320 may be axially separated to permit loading of drum 300 and tire curing bladder 312 into the interior of mold ring 320. Mold ring 320 may be axially closed to permit molding of tire curing bladder 312.

Mold ring 320 may include an inner surface 321.

Mold ring 320 may include a plurality of mold portions, including a first mold ring portion 322A and a second mold ring portion 322B. First mold ring portion 322A may be oriented on a first side of drum 300. Second mold ring portion 322B may be oriented on a second side of drum 300, substantially opposite first mold ring portion 322A.

Mold 301 may include at least one outside bead ring, including in one embodiment a first outside bead ring 324A and a second outside bead ring 324B.

Mold 301 may not include any mold spacer rings (not shown), such that first mold ring portion 322A and second mold ring portion 322B directly contact one another.

The axially outer edges of tire curing bladder 312 may be separated by a distance or width W.

A fluid, such as a hot gas, a hot liquid, a steam, or the like, may be introduced to the interior of drum 300. The fluid may pass through at least one orifice 306. The fluid may have a pressure Pi within drum 300. The fluid may have a pressure Po between cylindrical wall 304 and tire curing bladder 312.

A fluid under pressure Po may be used to inflate tire curing bladder 312 at least partially. A fluid under pressure Po may be used to inflate tire curing bladder 312 into at least partial contact with inner surface 321. A fluid under pressure may be used to inflate tire curing bladder 312 into contact with inner surface 321. Tire curing bladder 312 may be cured while in contact with inner surface 321. Tire curing bladder 312 may be cured via contact with a heated fluid, contact with heated mold ring 320, or a combination thereof.

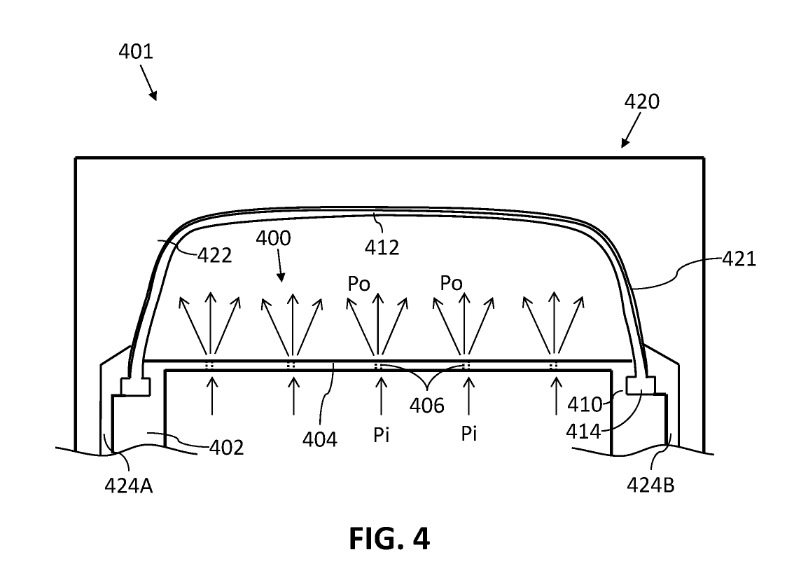

FIG. 4 illustrates a sectional view of a mold 401 for manufacturing a tire curing bladder 412.

Drum 400 may include at least one end cap 402, a cylindrical wall 404, and at least one orifice 406 oriented in cylindrical wall 404. Drum 400 may include at least one inside bead 410. A tire curing bladder 412 may be built upon drum 400. Tire curing bladder 412 may include at least one foot 414. At least one foot may at least partially engage at least one inside bead 410.

Mold 401 may include at least one mold ring 420. Mold ring 420 may be a segmented mold ring, such that a plurality of portions of mold ring 420 each extend partially circumferentially about drum 400, and when assembled with other portions, completely surround drum 400.

Mold ring 420 may include an inner surface 421.

Mold 401 may include at least one outside bead ring, including in one embodiment a first outside bead ring 424A and a second outside bead ring 424B.

The axially outer edges of tire curing bladder 412 may be separated by a distance or width W.

A fluid, such as a hot gas, a hot liquid, a steam, or the like, may be introduced to the interior of drum 400. The fluid may pass through at least one orifice 406. The fluid may have a pressure Pi within drum 400. The fluid may have a pressure Po between cylindrical wall 404 and tire curing bladder 412.

A fluid under pressure may be used to inflate tire curing bladder 412 at least partially. A fluid under pressure Po may be used to inflate tire curing bladder 412 into at least partial contact with inner surface 421. A fluid under pressure Po may be used to inflate tire curing bladder 412 into contact with inner surface 421. Tire curing bladder 412 may be cured while in contact with inner surface 421. Tire curing bladder 412 may be cured via contact with a heated fluid, contact with heated mold ring 420, or a combination thereof.

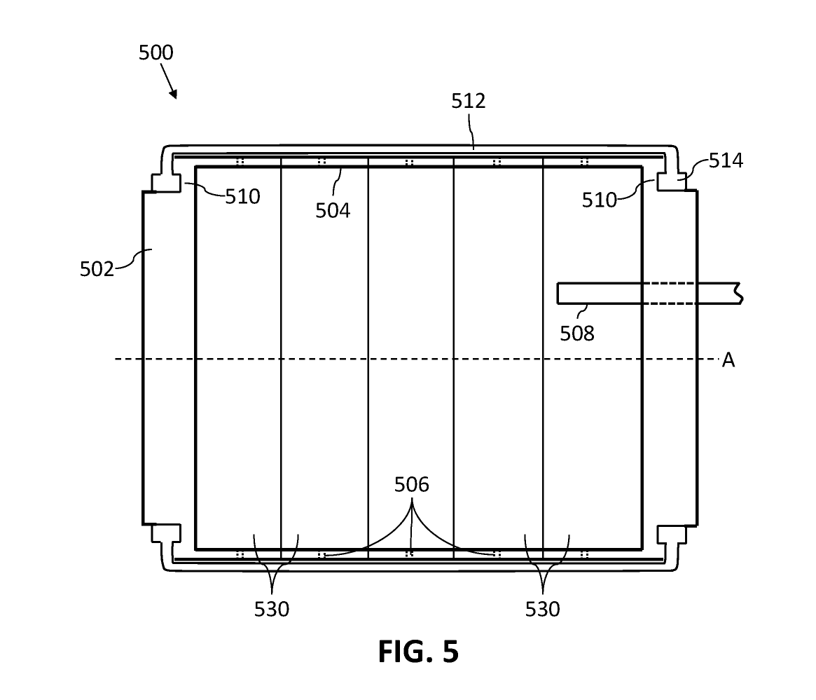

FIG. 5 illustrates a drum 500 for building a tire curing bladder 512. Drum 500 may include end caps 502 and a cylindrical wall 504. Cylindrical wall 504 may include at least one orifice 506. Drum 500 may include a fluid supply 508. Drum 500 may include at least one inside bead 510. Tire curing bladder 512 may include at least one foot 514. Drum 500 may include at least one drum spacer ring 530.

At least one drum spacer ring 530 may be oriented between end caps 502. At least one drum spacer ring 530 may be oriented between end caps 502 in order to achieve the desired width in the designed tire curing bladder 512. In one embodiment, additional drum spacer rings 530 may be added to drum 500 to increase the width of drum 500 so as to achieve the desired width in the designed tire curing bladder 512. In another embodiment, less, or no, drum spacer rings 530 may be added to drum 500 to decrease the width of drum 500 so as to achieve the desired width in the designed tire curing bladder 512.

At least one drum spacer ring 530 may be substantially similar to cylindrical wall 504, but truncated. At least one drum spacer ring 530 may include at least one orifice 506. Alternatively, at least one or more drum spacer ring 530 may not include an orifice 506.

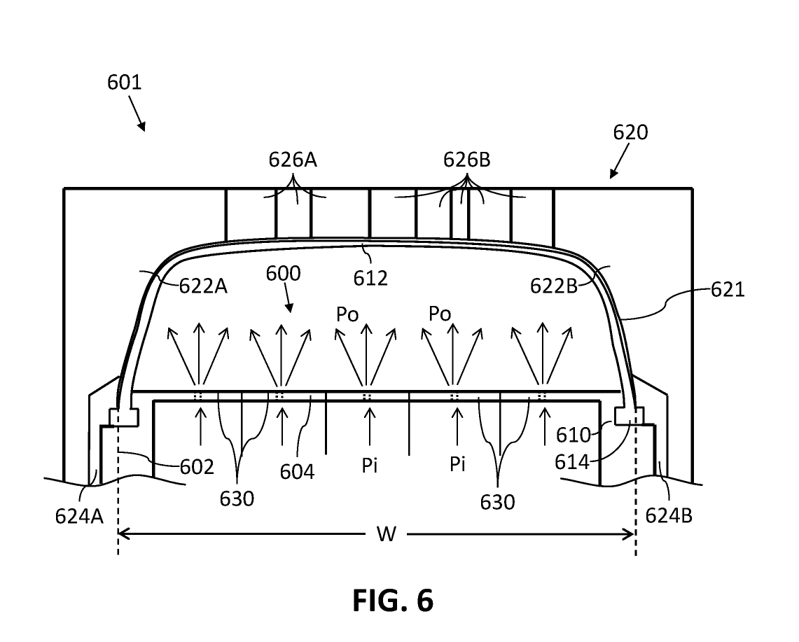

FIG. 6 illustrates a sectional view of a mold 601 for manufacturing a tire curing bladder 612. Mold 601 may be used in conjunction with a drum 600.

Drum 600 may include at least one end cap 602, a cylindrical wall 604, and at least one orifice 606 oriented in cylindrical wall 604. Drum 600 may include at least one inside bead 610. A tire curing bladder 612 may be built upon drum 600. Tire curing bladder 612 may include at least one foot 614. At least one foot may at least partially engage at least one inside bead 610. Drum 600 may include at least one drum spacer ring 630.

Mold 601 may include at least one mold ring 620. As illustrated in FIG. 6, mold ring 620 may be axially separated to permit loading of drum 600 and tire curing bladder 612 into the interior of mold ring 620. Mold ring 620 may be axially closed to permit molding of tire curing bladder 612.

Mold ring 620 may include an inner surface 621.

Mold ring 620 may include a plurality of mold portions, including a first mold ring portion 622A and a second mold ring portion 622B. First mold ring portion 622A may be oriented on a first side of drum 600. Second mold ring portion 622B may be oriented on a second side of drum 600, substantially opposite first mold ring portion 622A.

Mold 601 may include at least one outside bead ring, including in one embodiment a first outside bead ring 624A and a second outside bead ring 624B.

Mold 601 may include at least one mold spacer ring 626A, 626B. At least one mold spacer ring 626A, 626B may be oriented between at least one mold ring portion 622A, 622B prior to application of at least one mold ring portion 622A, 622B in order to achieve the desired width W in the designed tire curing bladder 612.

At least one drum spacer ring 630 may be oriented between end caps 602 in order to achieve the desired width W in the designed tire curing bladder 612. At least one drum spacer ring 630 may be added or removed from drum 600 as necessary to properly match the width of drum 600 to the width of mold 601. In this manner, mold 601 and drum 600 can be adjusted in width relative to one another so as to allow manufacture of tire curing bladders 612 of any of various sizes, utilizing the same mold 601 and drum 600 for the manufacture of each.

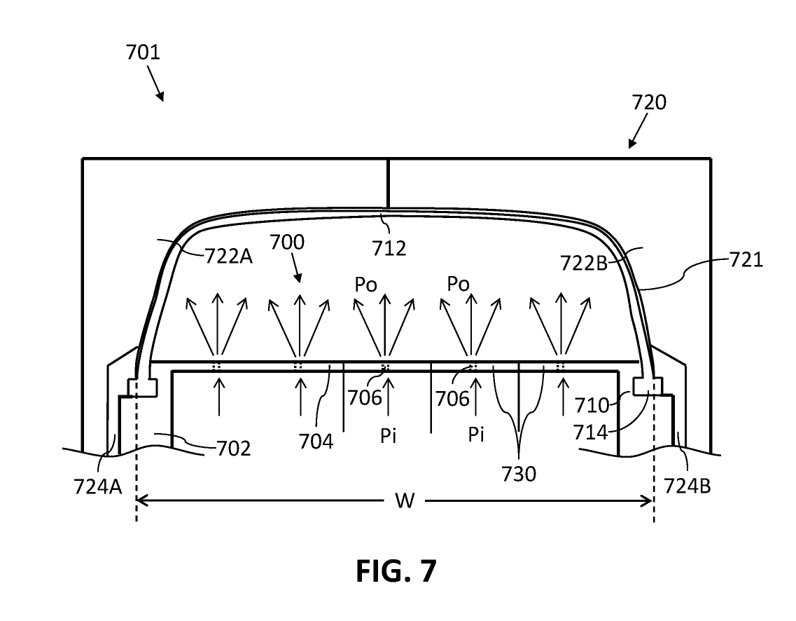

FIG. 7 illustrates a sectional view of a mold 701 for manufacturing a tire curing bladder 712. Mold 701 may be used in conjunction with a drum 700.

Drum 700 may include at least one end cap 702, a cylindrical wall 704, and at least one orifice 706 oriented in cylindrical wall 704. Drum 700 may include at least one inside bead 710. A tire curing bladder 712 may be built upon drum 700. Tire curing bladder 712 may include at least one foot 714. At least one foot may at least partially engage at least one inside bead 710. Drum 700 may include at least one drum spacer ring 730.

Mold 701 may include at least one mold ring 720. As illustrated in FIG. 7, mold ring 720 may be axially separated to permit loading of drum 700 and tire curing bladder 712 into the interior of mold ring 720. Mold ring 720 may be axially closed to permit molding of tire curing bladder 712.

Mold ring 720 may include an inner surface 721.

Mold ring 720 may include a plurality of mold portions, including a first mold ring portion 722A and a second mold ring portion 722B. First mold ring portion 722A may be oriented on a first side of drum 700. Second mold ring portion 722B may be oriented on a second side of drum 700, substantially opposite first mold ring portion 722A.

Mold 701 may include at least one outside bead ring, including in one embodiment a first outside bead ring 724A and a second outside bead ring 724B.

At least one drum spacer ring 730 may be oriented between end caps 702 in order to achieve the desired width W in the designed tire curing bladder 712. At least one drum spacer ring 730 may be added or removed from drum 700 as necessary to properly match the width of drum 700 to the width of mold 701. In this manner, drum 700 can be adjusted in width relative to mold 701 so as to allow manufacture of tire curing bladders 712 of any of various sizes, utilizing the same mold 701 and drum 700 for the manufacture of each.

In practice, a user may manufacture tire curing bladder 112, 212, 312, 412, 512, 612, 712 via any of a variety of manners. In one embodiment, an uncured tire curing bladder 112, 212, 312, 412, 512, 612, 712 may be built on drum 100, 200, 300, 400, 500, 600, 700. Tire curing bladder 112, 212, 312, 412, 512, 612, 712 may be built via the application of a single layer, or multiple layers, of one or more compound to drum 100, 200, 300, 400, 500, 600, 700.

At least a portion of tire curing bladder 112, 212, 312, 412, 512, 612, 712 may be contacted with at least one inside bead 110, 210, 310, 410, 510, 610, 710 to form an axially inner portion of foot 114, 214, 314, 414, 514, 614, 714. At least one of outside bead rings 224A, 224B, 324A, 324B, 424A, 424B, 624A, 624B, 724A, 724B may be connected to drum 100, 200, 300, 400, 500, 600, 700 via clamping, fastening, or the like. Application of at least one of outside bead rings 224A, 224B, 324A, 324B, 424A, 424B, 624A, 624B, 724A, 724B may form an axially outer portion of foot 114, 214, 314, 414, 514, 614, 714.

At least one mold ring portion 222A, 222B, 322A, 322B, 622A, 622B, 722A, 722B may be connected to drum 100, 200, 300, 400, 500, 600, 700. At least one mold spacer ring 226A, 226B, 626A, 626B may be oriented between at least one mold ring portion 222A, 222B, 622A, 622B prior to application of at least one mold ring portion 222A, 222B, 622A, 622B in order to achieve the desired width W in the designed tire curing bladder 112, 212, 312, 412, 512, 612, 712. At least one drum spacer ring 530, 630, 730 may be added to or removed from drum 500, 600, 700. The drum 100, 200, 300, 400, 500, 600, 700 and mold 201, 301, 401, 601, 701 assembly may be placed into a tire curing press (not shown).

In one embodiment, at least one mold ring portion 222A, 222B, 322A, 322B, 622A, 622B, 722A, 722B may be inserted into a tire curing press (not shown), after which drum 100, 200, 300, 400, 500, 600, 700 may be placed in the tire curing press.

Upon placement of the drum 100, 200, 300, 400, 500, 600, 700 and mold 201, 301, 401, 601, 701 assembly into the tire curing press, the tire curing press may be sealed and a fluid may be applied to the interior of drum 100, 200, 300, 400, 500, 600, 700 via a supply, including for example fluid supply 108, 508. The fluid may be a steam or otherwise heated liquid or gas. The fluid may be pressurized to a pressure Pi. The fluid may flow through at least one orifice 106, 206, 306, 406, 506, 606, 706. The fluid may create a pressure Po within the area between drum 100, 200, 300, 400, 500, 600, 700 and tire curing bladder 112, 212, 312, 412, 512, 612, 712. Tire curing bladder 112, 212, 312, 412, 512, 612, 712 may be inflated until it contacts inner surface 221, 321, 421, 621, 721. Tire curing bladder 112, 212, 312, 412, 512, 612, 712 may remain inflated and in contact with inner surface 221, 321, 421, 621, 721 during the entire period that it undergoes curing. Heat for curing of tire curing bladder 112, 212, 312, 412, 512, 612, 712 may be provided via a heated fluid used for inflation, heating of mold 201, 301, 401, 601, 701 or a combination thereof. Following curing of tire curing bladder 112, 212, 312, 412, 512, 612, 712 tire curing bladder 112, 212, 312, 412, 512, 612, 712 may be removed from the tire curing press (not shown), mold 201, 301, 401, 601, 701, and drum 100, 200, 300, 400, 500, 600, 700.

The cured tire curing bladder 112, 212, 312, 412, 512, 612, 712 may be used to cure any of a variety of tires, including pneumatic tires or non-pneumatic tires.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See Bryan A. Garner, A Dictionary of Modern Legal Usage 624 (2d. Ed. 1995). Also, to the extent that the terms “in” or “into” are used in the specification or the claims, it is intended to additionally mean “on” or “onto.” To the extent that the term “substantially” is used in the specification or the claims, it is intended to take into consideration the degree of precision available or prudent in manufacturing. To the extent that the term “selectively” is used in the specification or the claims, it is intended to refer to a condition of a component wherein a user of the apparatus may activate or deactivate the feature or function of the component as is necessary or desired in use of the apparatus. To the extent that the term “operatively connected” is used in the specification or the claims, it is intended to mean that the identified components are connected in a way to perform a designated function. As used in the specification and the claims, the singular forms “a,” “an,” and “the” include the plural. Finally, where the term “about” is used in conjunction with a number, it is intended to include ±10% of the number. In other words, “about 10” may mean from 9 to 11.

As stated above, while the present application has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art, having the benefit of the present application. Therefore, the application, in its broader aspects, is not limited to the specific details, illustrative examples shown, or any apparatus referred to. Departures may be made from such details, examples, and apparatuses without departing from the spirit or scope of the general inventive concept.

1. A system for curing a tire curing bladder, comprising:
a tire building drum, including:
at least one end cap having at least one inside bead; and
a cylindrical wall;
wherein the tire building drum includes an axis of rotation and wherein the axis of rotation extends through the at least one end cap, and
wherein the cylindrical wall includes at least one orifice;
a mold, including:
a mold ring oriented at least partially radially outwardly of the tire building drum, wherein the mold ring includes a first mold ring portion and a second mold ring portion, wherein each of the first mold ring portion and the second mold ring portion are oriented axially adjacent to one another; and
at least one outside bead ring; and
a tire curing press.

2. The system of claim 1, wherein at least one mold spacer ring is oriented axially between the first mold ring portion and the second mold ring portion.

3. The system of claim 1, further comprising a tire curing bladder formed circumferentially about an exterior surface of the cylindrical wall.

4. The system of claim 3, wherein the tire curing bladder includes at least one foot, wherein the tire building drum further comprises at least one inside bead, and wherein the at least one foot is at least partially engaged with the at least one inside bead.

5. The system of claim 3, wherein the tire curing bladder includes at least one foot, and wherein the at least one foot is at least partially engaged with the at least one outside bead ring.

6. The system of claim 1, wherein at least one drum spacer ring is oriented axially between a first end cap and a second end cap.

7. The system of claim 1, further comprising a fluid within an interior of the tire building drum and wherein the fluid is a pressurized steam.

8. A system for curing a tire curing bladder, comprising:
a tire building drum, including:
at least one end cap; and
a cylindrical wall;
wherein the tire building drum includes an axis of rotation and wherein the axis of rotation extends through the at least one end cap, and
wherein the cylindrical wall includes at least one orifice;
a mold, including:
a mold ring oriented at least partially radially outwardly of the tire building drum; and
at least one outside bead ring; and
a tire curing press.

9. The system of claim 8, wherein the mold ring comprises a first mold ring portion and a second mold ring portion, wherein each of the first mold ring portion and the second mold ring portion are oriented axially adjacent to one another.

10. The system of claim 9, wherein at least one mold spacer ring is oriented axially between the first mold ring portion and the second mold ring portion.

11. The system of claim 8, wherein the tire building drum further comprises at least one inside bead oriented on the at least one end cap.

12. The system of claim 8, further comprising a tire curing bladder formed circumferentially about an exterior surface of the cylindrical wall.

13. The system of claim 12, wherein the tire curing bladder includes at least one foot, wherein the tire building drum further comprises at least one inside bead, and wherein the at least one foot is at least partially engaged with the at least one inside bead.

14. The system of claim 12, wherein the tire curing bladder includes at least one foot, and wherein the at least one foot is at least partially engaged with the at least one outside bead ring.

15. The system of claim 12, wherein the tire curing bladder includes at least one foot, wherein the tire building drum further comprises at least one inside bead, and wherein the at least one foot is molded via the at least one inside bead.

16. The system of claim 12, wherein the tire curing bladder includes at least one foot, and wherein the at least one foot is molded via the at least one outside bead ring.

17. The system of claim 8, wherein at least one drum spacer ring is oriented axially between a first end cap and a second end cap.

18. The system of claim 8, further comprising a fluid supply in fluid communication with the at least one orifice.

19. The system of claim 8, further comprising a fluid within an interior of the tire building drum and wherein the fluid is a pressurized steam.

20. The system of claim 10, further comprising a tire curing bladder formed circumferentially about an exterior surface of the cylindrical wall, wherein the tire curing bladder includes axially outer edges separated by a width, and wherein the at least one mold spacer ring causes an inner surface of the mold to increase the width.
